(19) United States
(12) Patent Application Publication
(10) Pub. No.: US 2005/0009195 A1
(43) Pub. Date: Jan. 13, 2005

(54) Device for analyzing the alcohol content of respiratory gas

(76) Inventor: Chi-Hsiang Wang, Taipei (TW)

Correspondence Address: MERONI + MERONI, P.O. BOX 309, BARRINGTON, IL, 60011, US

(21) Appl. No.: 10/888,333

(22) Filed: Jul. 9, 2004

(30) Foreign Application Priority Data
Jul. 22, 2003 (CN) 03272653.3
Jul. 9, 2003 (TW) 092212574

(51) Int. Cl. G01N 27/00

(52) U.S. Cl. 436/132; 422/98

(57) ABSTRACT

Disclosed is a hand-held device for analyzing the alcohol content found in expelled respiratory gas, the device comprising an outer analyzer housing, a gas analysis and readout assembly, and a control circuit. The expulsion of respiratory gas into the device rotates a fan member. The number of revolutions of the fan member generates a revolution signal that is compared to a predetermined revolution value programmed into the control circuit. When the comparison generates a positive result, alcohol detecting means sample and test the respiratory gas passing through the device. The device thus forces the user to expel so-called low-lung, residual respiratory gas, which gas typically comprises more accurate levels of alcohol as compared to the consumer's blood alcohol content. If the comparison results in a negative signal, the user is prompted to repeat the procedure until a reading of low-lung respiratory gas has been acquired.

### BACKGROUND OF THE INVENTION

1. Field of the Invention

The present invention generally relates to a device for analyzing the alcohol content in a user's breath. More particularly, the present invention relates to a device for accurately analyzing the alcohol content that may be found in an alcohol consumer's so-called “low-lung” or deep lung respiratory gas so as to more effectively address safety concerns associated with the consumption or ingestion of alcohol.

2. Description of the Prior Art

Alcohol is a technical term denoting a family of organic chemicals with certain common properties. Members of this family include ethanol, methanol, and isopropanol. Perhaps the most commonly known of these alcohols is ethanol, which is frequently ingested or consumed as an intoxicant. Alcohol (ethanol) is a clear, volatile liquid that burns (oxidizes) easily. It has a slight, characteristic odor and is soluble in water. When ingested, alcohol acts as a central nervous system depressant and it is the central nervous system that is most severely affected by alcohol. The degree to which the central nervous system function is impaired is directly proportional to the concentration of alcohol in the blood. When ingested, alcohol passes from the stomach into the small intestine, where it is rapidly absorbed into the blood and distributed throughout the body. Because alcohol is distributed so quickly and thoroughly, it can affect the central nervous system even in small concentrations.

In low concentrations, alcohol reduces inhibitions and provides the consumer with a mild sense of euphoria. As blood alcohol concentration increases, however, a consumer's response to stimuli decreases markedly, speech becomes slurred, and he or she becomes unsteady and has trouble walking. With very high concentrations—greater than 0.35 grams/100 milliliters of blood (equivalent to 0.35 grams/210 liters of breath)—a consumer can become comatose and die. The American Medical Association has defined the blood alcohol concentration level of impairment for all people to be 0.04 grams/100 milliliters of blood (equivalent to 0.04 grams/210 liters of breath). The following is a generally accepted guide to the effects of alcohol.

Stages of alcohol intoxication¹

| BAC | | |
|---|---|---|
| (g/100 ml of blood | | |
| or g/210 l of | | |
| breath) | Stage | Clinical symptoms |
| 0.01-0.05 | Subclinical | Behavior nearly normal by ordinary observation |
| 0.03-0.12 | Euphoria | Mild euphoria, sociability, talkativeness, increased self-confidence; |
| | | decreased inhibitions, diminution of attention, judgment and control, |
| | | beginning of sensory-motor impairment, loss of efficiency in finer |
| | | performance tests |
| 0.09-0.25 | Excitement | Emotional instability; loss of critical judgment, impairment of perception, |
| | | memory and comprehension, decreased sensitory response; increased |
| | | reaction time, reduced visual acuity; peripheral vision and glare recovery, |
| | | sensory-motor incoordination; impaired balance, drowsiness |
| 0.18-0.30 | Confusion | Disorientation, mental confusion; dizziness, exaggerated emotional states |
| | | Disturbances of vision and of perception of color, form, motion and |
| | | dimensions, increased pain threshold, increased muscular incoordination; |
| | | staggering gait; slurred speech, apathy, lethargy |
| 0.25-0.40 | Stupor | General inertia; approaching loss of motor functions, markedly decreased |
| | | response to stimuli, marked muscular incoordination; inability to stand or |
| | | walk, vomiting; incontinence, Impaired consciousness; sleep or stupor |
| 0.35-0.50 | Coma | Complete unconsciousness, depressed or abolished reflexes, subnormal |
| | | body temperature, incontinence, impairment of circulation and respiration, |
| | | possible death |
| 0.45 + | Death | Death from respiratory arrest |

Alcohol is absorbed from all parts of the gastrointestinal tract largely by simple diffusion into the blood. However the small intestine is by far the most efficient region of the gastrointestinal tract for alcohol absorption because of its very large surface area. In a fasting individual, it is generally agreed that 20% to 25% of a dose of alcohol is absorbed from the stomach and 75% to 80% is absorbed from the small intestine. Because of this peak blood alcohol concentrations are achieved in fasting people within 0.5 to 2.0 hours, (average 0.75-1.35 hours depending upon dose and time of last meal) while non-fasting people exhibit peak alcohol concentrations within 1.0 hour, and in extreme cases up to as much as 6.0 hours (average 1.06-2.12 hours).

Alcohol has a high affinity for water and is therefore found in body tissues and fluids inasmuch as they contain water. Absorbed alcohol is rapidly carried throughout the body in the blood and once absorption of alcohol is complete an equilibrium occurs such that blood at all points in the system contains approximately the same concentration of alcohol. The liver is responsible for the elimination—through metabolism—of approximately 95% of ingested alcohol from the body. The remainder of the alcohol is eliminated through excretion of alcohol in breath, urine, sweat, feces, milk and saliva.

The body uses several different metabolic pathways in its oxidation of alcohol to acetaldehyde to acetic acid to carbon dioxide and water. Healthy people metabolize alcohol at a fairly consistent rate. As a rule of thumb, a person will eliminate one average drink or 0.5 oz (15 ml) of alcohol per hour. Several factors influence this rate. The rate of elimination tends to be higher when the blood alcohol concentration in the body is very high or very low. Also chronic alcoholics may (depending on liver health) metabolize alcohol at a significantly higher rate than average. Finally, the body's ability to metabolize alcohol quickly tends to diminish with age.

In general, the less one weighs the more one will be affected by a given amount of alcohol. As detailed above, alcohol has a high affinity for water. Basically one's blood alcohol concentration is a function of the total amount of alcohol in one's system divided by total body water. So for two individuals with similar body compositions and different weights, the larger individual will achieve lower alcohol concentrations than the smaller one if ingesting the same amount of alcohol. However, for people of the same weight, a well-muscled individual will be less affected than someone with a higher percentage of fat since fatty tissue does not contain very much water and will not absorb very much alcohol.

Blood alcohol concentration depends on the amount of alcohol consumed and the rate at which the user's body metabolizes alcohol. Because the body metabolizes alcohol at a fairly constant rate (somewhat more quickly at higher and lower alcohol concentrations), ingesting alcohol at a rate higher than the rate of elimination results in a cumulative effect and an increasing blood alcohol concentration. Thus, it should be understood that blood alcohol concentration is directly proportional to the quantity and speed with which alcohol is consumed.

The ingestion of alcohol has a long and varied history and is common the world over. Most frequently, beverages containing alcohol are ingested as a catalyst to joy. In this regard, it will be recalled that in low concentrations (0.03-0.12 g/210 liters of breath), the alcohol user experiences mild euphoria, sociability, talkativeness, increased self-confidence, and decreased inhibitions. Oftentimes, these typically positive symptoms lead the user to ingest further quantities of alcohol. At higher blood alcohol concentrations (0.08 g/100 ml of blood and above), the blood alcohol content (BAC) can lead to potentially serious safety concerns. It will be further recalled that there are a host of negative symptoms associated with the ingestion of larger amounts of alcohol, including diminution of attention, judgment and control; sensory-motor impairment; loss of efficiency in finer performance tests; emotional instability; loss of critical judgment; impairment of perception, memory and comprehension; decreased sensitory response; increased reaction time; reduced visual acuity, peripheral vision, and glare recovery; sensory-motor incoordination; impaired balance; and drowsiness. Persons with elevated BAC's unfortunately make the mistake (through impaired judgment) of driving vehicles while intoxicated. So-called “drunk driving” is often regarded as an unscheduled time bomb, and there are countless examples of car accidents caused by drunk driving. In response to this unfortunate societal problem, strict rules and penalties for drunk driving have been legislated and continue to be stringently enforced. In an attempt to provide the enforcement community with a means to quickly and effectively measure one's BAC during a traffic stop, a number of BAC detectors have been developed. Some of the more pertinent alcohol detecting devices or so-called breathalyzers are briefly described hereinafter:

U.S. Pat. No. 4,163,383 ('383 Patent), which issued to VanderSyde et al., discloses a Breath Testing System. The '383 Patent teaches a breath tester comprising an electronic detector that provides an information signal with an amplitude level which varies as a function of the alcohol content in the breath under test. An anomaly detector circuit stores a signal related to the peak of the information signal, and continually compares this peak value with the instantaneous value of the information signal. When the difference between the peak signal level and the instantaneous signal level exceeds a preset amount, the output display of the breath tester is modified to indicate the analysis process has been disturbed by an anomalous chemical substance.

U.S. Pat. No. 4,448,058 ('058 Patent), which issued to Jaffe et al., discloses a Respiratory Gas Analysis Instrument Having Improved Volume Calibration Method and Apparatus. The '058 Patent teaches an improved gas volume calibration method and apparatus for use in respiratory gas analyzers. A control unit monitors the flow of calibration gas through the analyzer by monitoring the electrical signals produced by a gas turbine and a breath switch. During calibration, a known volume of calibration gas is repeatedly delivered to the analyzer from a calibration syringe at each of a number of different flow rates. On the basis of the information received from the turbine and the breath switch, the control unit generates and stores a piecewise linear approximation of the nonlinear characteristic of the turbine. This stored turbine characteristic is then made available during subsequent measurements to eliminate those volume errors which are associated with variations in the rate at which the sample gas is delivered, thereby affording measurements of improved accuracy.

U.S. Pat. No. 5,055,268 ('268 Patent), which issued to Martin, discloses an Air-Borne Alcohol Sensor. The '268 patent teaches an air-borne chemical sensor system comprising a motor and impeller to draw an air sample into a housing containing a sensor which will provide a signal for display related to the amount of a particular air-borne chemical in a given air sample. The system is controllable by different duration activation of a single activating switch which can further control a secondary function.

U.S. Pat. No. 5,303,575 ('575 Patent), which issued to Brown et al., discloses an Apparatus and Method for Conducting an Unsupervised Blood Alcohol Content Level Test. The '575 Patent teaches an automated unsupervised apparatus for conducting a blood alcohol content level test on an individual user, and subsequently discerning and displaying a meaningful test result. A pressure switch is used to monitor the gauge pressure of the individual user's breath sample in order to determine whether the gauge pressure is at or above a threshold value for a predetermined length of time. An acceptable testing sample of the individual user's breath is captured in a fuel cell tpe alcohol concentration sensor. The alcohol concentration sensor effects an automated electrochemical analysis of the testing sample.

In addition to the foregoing, the typical police station breath testing equipment requires the examinee to blow air into a pipe for approximately 3-4 seconds. This prolonged period of respiratory exhaust is required so that the total force of air depresses a pressure valve in the alcohol-detecting unit thereby allowing exhausted respiratory gas to flow past an alcohol detecting sensor for sampling and testing. The sampled and tested sample is then typically processed by a central processing unit, and the results are printed out for use as forensic evidence. It will thus be seen that the accuracy of the typical station devices depends on the user's ability to depress the pressure valve with forced air. This requires the user to exhaust otherwise deep, residual, low-lung air from the user's lungs, which residual air typically comprises a more accurate BAC level. In other words, accurate readings depend on the user's ability to exhaust air from deep down in his or her lungs, which low-lung air is laden with more accurate levels of alcohol. It is this alcohol-laden air which the properly functioning BAC detector samples and analysis.

Police station BAC analysis equipment is often bulky and cumbersome and not readily portable to the sites at which police suspect instances of drunk-driving. Manufacturers have focused research and development efforts on developing portable units. Yet the portable BAC analysis units that have been developed have common shortcomings. For example, for blow-pipe type portable detectors, it is often difficult for the user to exchange or interchange blow pipe structures. Further, the poor design of the airflow control valve housed within these units makes the expulsion of low-lung respiratory gas difficult. Perhaps most importantly, the indefinite respiratory gas exhaust results in inaccurate measurements and mistakes. Thus, the prior art perceives a need for a BAC analysis device that enables the user to properly exhaust low-lung air so as to effect accurate BAC readings.

### SUMMARY OF THE INVENTION

It is thus an object of the present invention to provide a device for analyzing the alcohol content of respiratory gas. More specifically, it is an object of the present invention to provide a portable device for analyzing the alcohol content of so-called low-lung or deep lung respiratory gas. In this regard, it is an object of the present invention to provide a small compact BAC analysis device that forces the user to exhaust low-lung, residual respiratory gas into the device so that sampling, testing, processing and readings of the BAC may be made more accurate.

To achieve these and other readily apparent objectives, the present invention essentially comprises a hand-held device of analyzing the alcohol content found in low-lung or residual respiratory gas. The device essentially comprises an outer analyzer housing, a gas analysis and readout assembly, a control circuit, and power means. The hand-held or hand-holdable outer analyzer housing essentially comprises a proximal end, a distal end, a superior surface, and an inferior surface. The proximal end comprises a respiratory gas inlet adjacent the superior surface and a respiratory gas outlet adjacent the inferior surface. The superior surface comprises a display screen window and a control key-receiving aperture intermediate the proximal end and the distal end. The inferior surface comprises a compartment access aperture and a compartment lid adjacent the distal end. Essentially, the outer analyzer housing is designed to enclose a circuit assembly-receiving compartment and a power means-receiving compartment, the circuit assembly-receiving compartment being spatially located adjacent the proximal end and the power means-receiving compartment being spatially located adjacent the distal end. The compartment lid is designed to cover the power means-receiving compartment and the compartment access aperture.

The gas analysis and readout assembly is received in the circuit assembly-receiving compartment and essentially comprises a circuit board assembly and a respiratory gas identifying assembly. The circuit board assembly comprises alcohol detecting means, a display screen, a control key, and a circuit board. The display screen is spatially located adjacent the display screen window for displaying a visual output display through the display screen window. The control key is received in the control key-receiving aperture and is electrically coupled to the circuit board for selectively initiating respiratory gas analysis at the prompt of the user. The respiratory gas identifying assembly essentially comprises a frame, at least one fixing aperture, an axial panel, circuit means, first signal generating means, second signal generating means, and a circular fan member. The axial panel couples the circuit means to the first signal generating means. The fan member comprises a plurality of circumferentially spaced fan blades and a fan axle, the fan axle having an axis of rotation extending therethrough. Further, the fan axle is operatively coupled to the axial panel. The second signal generating means is cooperatively associated with the fan member for generating a revolution signal receivable and interpretable by the first signal generating means.

The control circuit is programmed with a predetermined revolution value and thus compares the revolution signal to the predetermined revolution value, sending a select instructional signal to the circuit board assembly when the comparison has been made. The select instructional signal is selected from the group consisting of a positive, alcohol detector signal and a negative, error message signal. The alcohol detector signal initiates sampling and testing of expelled respiratory gas, which gas passes through the respiratory gas inlet, alcohol detecting means, and respiratory gas outlet. The error message signal initiates an error message display on the display screen. The sampling and testing of respiratory gas, in the event of receiving a positive, alcohol detector signal, results in a respiratory gas alcohol content display.

The power means is received in the power means-receiving compartment for delivering operational power to the gas analysis and readout assembly. The respiratory gas inlet receives and directs expelled respiratory gas through the alcohol detecting means, the respiratory gas identifying assembly, and the respiratory gas outlet. The expelled respiratory gas drives or turns or rotates the fan member and second signal generating means and the select instructional signal provides a user with the visual output display, the visual output display being either the respiratory gas alcohol content display or the error message display.

Other objects of the present invention, as well as particular features, elements, and advantages thereof, will be elucidated, or become apparent, from the following description and the accompanying drawing figures.

### BRIEF DESCRIPTION OF THE DRAWINGS

Other features of my invention will become more evident from a consideration of the following brief description of my patent drawings, as follows:

FIG. 1 is an exploded perspective view of the preferred embodiment of the device for analyzing the alcohol content of respiratory gas.

FIG. 2 is an exploded perspective view of the respiratory gas identifying assembly.

FIG. 3 is a cross sectional side view of the preferred embodiment of the device for analyzing the alcohol content of respiratory gas in an assembled state.

FIG. 4 is a circuit diagram detailing the electrical components comprising the circuit board.

### DETAILED DESCRIPTION OF THE PREFERRED EMBODIMENT

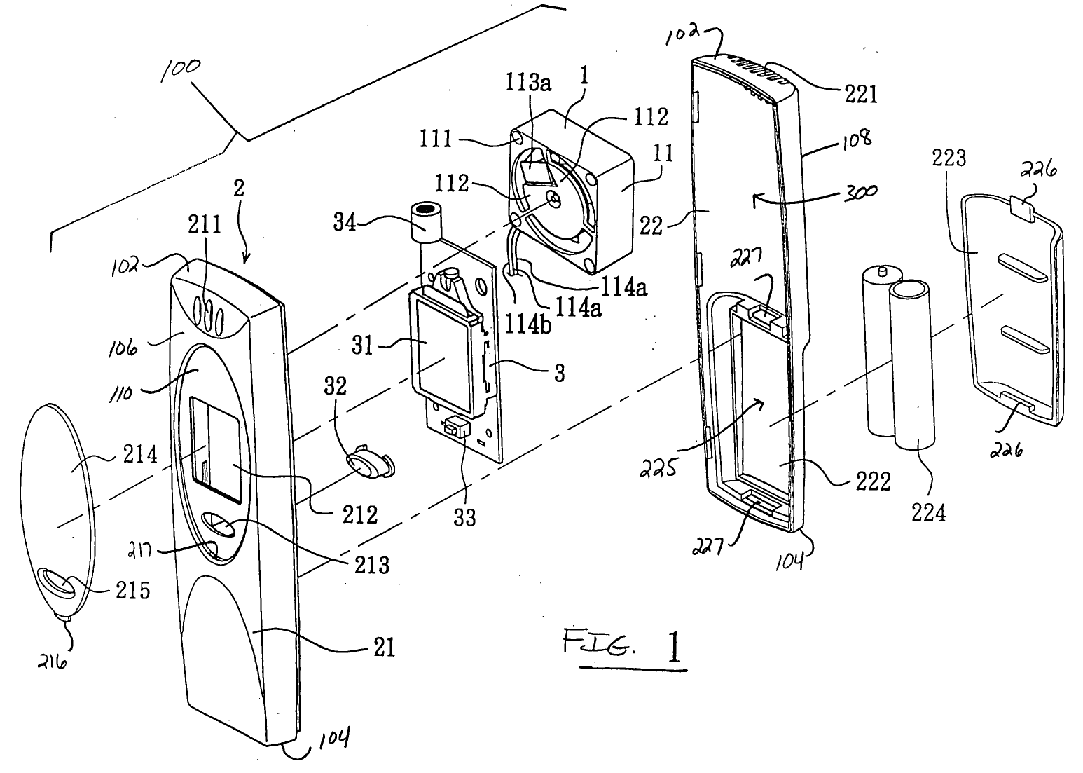

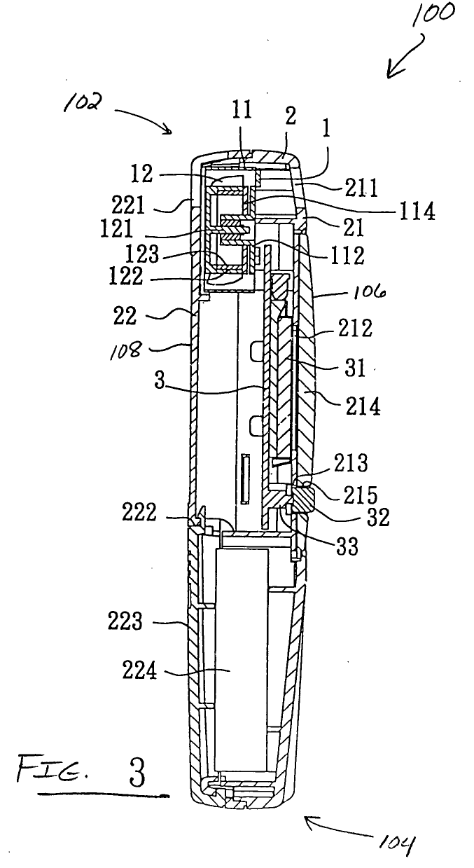

Referring now to the drawings, the preferred embodiment of the present invention concerns a user-friendly, hand-held device for analyzing the alcohol content of respiratory gas. The device may essentially be referred to as a blood alcohol content (BAC) analyzer 100 as generally illustrated and referenced in FIGS. 1 and 3. BAC analyzer 100 preferably comprises an outer encasement structure or outer analyzer housing sized and shaped to easily fit within the palm of a user's hand. In the preferred embodiment, the outer encasement structure is roughly or substantially box-like having a preferred length dimension of approximately 5.25 inches, a preferred width dimension of approximately 1.5 inches, and a preferred depth or height dimension of approximately 1 inch. In the preferred embodiment, the outer encasement structure comprises a first casing section 21 and a second casing section 22 both as illustrated and referenced in FIGS. 1 and 3. First casing section 21 and second casing section 22 are cooperatively matable with one another to form the outer encasement structure, which outer encasement structure houses a number of internal components described in more detail hereinafter.

The preferably dual-sectioned outer encasement structure comprises a proximal end 102 and a distal end 104, which ends have been referenced in FIGS. 1 and 3. It will be seen from a comparative inspection of FIGS. 1 and 3 that first casing section 21 comprises a superior portion of proximal end 102 and that second casing section 22 comprises an inferior portion of proximal end 102. In other words, when the outer encasement structure is spatially oriented for use, BAC analyzer 100 has a superior surface 106 and an inferior surface 108 as referenced in FIGS. 1 and 3. BAC analyzer 100 further preferably comprises a respiratory gas inlet 211 and a respiratory gas outlet 221. Respiratory gas inlet 211 is structurally situated at superior surface 106 adjacent proximal end 102 as illustrated and referenced in FIGS. 1 and 3 and respiratory gas outlet 221 is structurally situated at inferior surface 108 adjacent proximal end 102 as further illustrated and referenced in FIGS. 1 and 3. It will be seen from an inspection of the noted figures that respiratory gas inlet 211 and respiratory gas outlet 221 are essentially a series of apertures formed in the outer encasement structure or outer analyzer housing allowing expelled respiratory gas to pass therethrough.

First casing section 21 further preferably comprises a display screen window 212; and a casing-formed, control key-receiving aperture 213 as further illustrated and referenced in FIGS. 1 and 3. From an inspection of FIG. 1, it will be seen that superior surface 106 comprises a cover-receiving depression 110, which cover-receiving depression 110 is preferably formed as an oval-shaped depression in superior surface 106 adjacent both display screen window 212 and casing-formed, control key-receiving aperture 213, intermediate proximal end 102 and distal end 104. BAC analyzer 100 further preferably comprises a transparent cover member 214 as illustrated and referenced in FIGS. 1 and 3. Transparent cover member 214 is preferably sized and shaped to snugly seat into cover-receiving depression 110. Given the aesthetically preferred oval shape of cover-receiving depression 110, it is contemplated that transparent cover member 214 also be substantially oval-shaped in configuration. It should be noted that transparent cover member 214 is designed so as to provide both window viewing means and protection to display screen window 212. Given these functions, it is noted that other geometric shapes may be utilized for cover-receiving depression 110 and transparent cover member 214. It is contemplated that an oval shape simply provides a more aesthetically pleasing construction and thus it is this shape that has been illustrated for the reader.

It will be seen from a further inspection of FIGS. 1 and 3 that transparent cover member 214 further preferably comprises cover-formed, control key-receiving aperture 215. It will be seen from a comparative inspection of FIGS. 1 and 3 that when transparent cover member 214 is snugly seated into cover-receiving depression 110, cover-formed, control key-receiving aperture 215 is substantially axially aligned with casing-formed, control key-receiving aperture 213. Upon close inspection of FIG. 1 it will be seen that transparent cover member 214 and cover-receiving depression 110 further preferably comprise depression attachment means, which means may preferably be defined by a cover tab 216 (formed at the perimeter of transparent cover member 214) for insertion in a tab-receiving aperture 217 formed intermediate cover-receiving depression 110 and superior surface 106.

Second casing section 22 further preferably comprises a power source or power means-receiving compartment 222 as illustrated and referenced in FIGS. 1 and 3. It will be seen from an inspection of the noted figures that power means-receiving compartment 222 is preferably formed adjacent distal end 104. Access to power means-receiving compartment 222 is achieved via compartment access aperture 225, as illustrated and referenced in FIG. 1. Power means-receiving compartment 222 is covered (or compartment access aperture 225 is sealed) by a compartment lid 223 as illustrated and referenced in FIGS. 1 and 3. Compartment lid 223 and second casing section 22 further preferably comprise lid attachment means, which means may preferably be defined by lid tabs 226 and lid tab-receiving apertures 227. As is common in the art of this type, lid tabs 226 are preferably formed on compartment lid 223 and lid tab-receiving apertures 227 are preferably formed in second casing section 22 adjacent compartment access aperture 225 such that compartment lid 223 may be easily removably attached to second casing section 22 in inferior adjacency to power means-receiving compartment 222 (when BAC analyzer 100 is spatially oriented for use) by removably inserting lid tabs 226 into lid tab-receiving apertures 227.

It is contemplated that some power source or power means may be housed in power means-receiving compartment 222. The power means may preferably be defined by common electrochemically-based batteries, such as inexpensive AA dry-cell batteries 224 as illustrated and referenced in FIGS. 1 and 3. As illustrated, it is contemplated that BAC analyzer 100 may function given a power source comprising two AA dry-cell batteries 224 received in power source compartment 222. In the preferred embodiment, it is thus contemplated that power means-receiving compartment 222 is sized and shaped to receive two AA type dry-cell batteries. It should be noted that the power means need not be limited by electrochemically-based batteries as here exemplified. It is contemplated, for example, that an external power supply may be utilized to replace the dry-cell power source. It is contemplated that substitution of various different types of power sources is well within the skill of those ordinarily skilled in the art and thus further descriptions of this feature need not be further expounded upon in this writing.

BAC analyzer 100 further preferably comprises a respiratory gas identifying device or respiratory gas identifying assembly 1 as illustrated and referenced in FIGS. 1-3; a circuit board assembly 3 as illustrated and referenced in FIGS. 1 and 3; and alcohol detecting means 34 as illustrated in FIG. 1. Together respiratory gas identifying assembly 1, circuit board assembly 3, and alcohol detecting means 34 comprise a gas analysis and readout assembly. The gas analysis and readout assembly is received in the outer encasement structure intermediate first casing section 21 and second casing section 22 in a circuit assembly-receiving compartment 300 as generally referenced in FIG. 1. It will thus be understood from an inspection of FIGS. 1 and 3 that circuit assembly-receiving compartment 300 is preferably disposed intermediate first casing section 21 and second casing section 22 substantially adjacent proximal end 102.

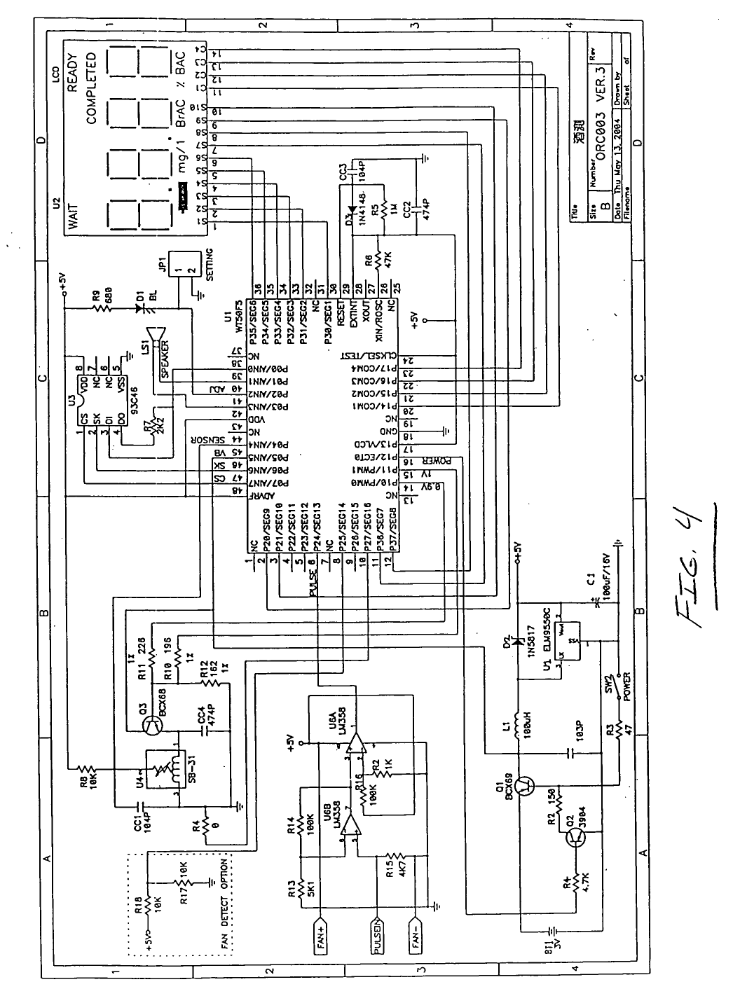

Circuit board assembly 3 preferably comprises a display screen 31 as illustrated and referenced in FIGS. 1 and 3; a press key 32 as illustrated and referenced in FIGS. 1 and 3; a control key 33 as illustrated and referenced in FIGS. 1 and 3; and a circuit board 35 as illustrated and referenced in FIGS. 1, 3, and 4. It will be seen that circuit board 35 comprises a number of common electrical components as specifically and schematically illustrated in FIG. 4. Display screen 31 is spatially oriented for juxtaposed placement adjacent display screen window 212 when the respiratory gas analysis and readout assembly is finally housed within the outer encasement structure. Thus, it will be understood that transparent cover member 214 functions to also protect display screen 31 as well as display screen window 212.

Display screen 31 is electrically coupled to circuit board 35 for receiving signals and displaying messages to the user of BAC analyzer 100. Control key 33 is electrically coupled to circuit board 35 for selectively initiating respiratory gas analysis at the election of the user (by pressing down control key 33). Press key 32 is cooperatively coupled or associated with control key 33 and serves as an intermediate between the user's fingers and control key 33. It will be understood from an inspection of FIGS. 1 and 3 that press key 32 is axially and movably received in axially-aligned, control key-receiving apertures 213 and 215. The alcohol detecting means 34 are spatially oriented or disposed intermediate respiratory gas inlet 211 and respiratory gas outlet 221 such that when respiratory gas is directed from respiratory gas inlet 211 to respiratory gas outlet 221, the alcohol detecting means 34 may readily detect the alcoholic content of the respiratory gas provided the alcohol detecting means is activated by an appropriate signal (as described in more detail hereinafter). The alcohol detecting means 34 are electrically coupled with circuit board 35 for providing circuit board assembly 3 with a respiratory gas alcohol content value for readout or display upon display screen 31.

Key to the functionality of the present invention is respiratory gas identifying assembly 1, which, in essence, replaces the pressure valves commonly incorporated into prior art BAC type devices. Essentially, respiratory gas identifying assembly 1 functions to determine whether the respiratory gas moving or passing from respiratory gas inlet 211 to respiratory gas outlet 221 (via the alcohol detecting means 34) is the correct or proper type of respiratory gas for accurate BAC analysis. The correct or proper type of respiratory gas (low-lung respiratory gas) is indirectly detected when a proper signal is generated. The noted signal generation is created by a critical minimum laminar respiratory gas flow through respiratory gas identifying assembly 1. In other words, BAC analyzer 100 will not provide the user with an accurate alcohol content reading unless the user directs a minimal laminar respiratory gas flow through respiratory gas identifying assembly 1.

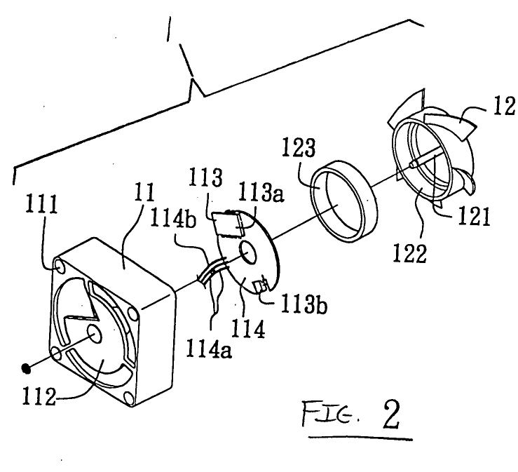

To achieve this objective, respiratory gas identifying assembly 1 preferably comprises a frame 11 as illustrated in FIGS. 1-3; a plurality of fixing apertures 111 as illustrated and referenced in FIGS. 1 and 2; an axial panel 112 as illustrated and referenced in FIGS. 1-3; circuit means 114 as illustrated and referenced in FIG. 2; first signal generating means 113 as illustrated and referenced in FIG. 2; second signal generating means 123 as illustrated and referenced in FIGS. 2 and 3; and a substantially circular fan member 122 as illustrated and referenced in FIGS. 2 and 3. It will be seen from an inspection of the noted figures that fixing apertures 111 are generally disposed around the periphery of frame 11, which fixing apertures 111 are cooperatively associated with fixing tenons (not specifically illustrated due the angle of projection) formed on the inner surface of first casing section 21 adjacent proximal end 102.

Axial panel 112 is structurally configured to couple the circuit means 114 to the first signal generating means 113 as comparatively depicted in FIGS. 1 and 2. The first signal generating means 113 may preferably be defined by comprising signal transmitting means and signal receiving means. The signal transmitting means may preferably be defined by comprising a signal sensor 113(b) and the signal receiving means may preferably be defined by comprising an encoder integrated circuit (IC) 113(a) substantially as illustrated in FIG. 2. The circuit means 114 may preferably be defined by comprising two power supply lines 114(a) and a signal line 114(b). Power supply lines 114(a) function to electrically couple the circuit means 114 to circuit board assembly 3 to complete a circuit and enable current flow therebetween. Signal line 114(b) is extended and electrically coupled to a control circuit (not specifically illustrated due to the angle of projection) for comparing and determining a number of generated signals.

Fan member 122 comprises an inner fan frame perimeter, an outer fan frame perimeter, at least one fan blade 12, and a fan axle 121 as generally illustrated and referenced in FIG. 2. It will be understood that fan axle 121 has an axis of rotation extending therethrough about which fan member 122 may freely rotate (under the force of expelled respiratory gas passing over fan blade(s) 12). Preferably, fan member 122 comprises a series of circumferentially spaced fan blades 12 as specifically illustrated in FIG. 2, the fan blade(s) being integrally formed with the outer fan frame perimeter. As is notable from a further inspection of FIG. 2, the preferred embodiment incorporates five (5) circumferentially spaced fan blades 12. Fan axle 121 is operatively coupled to axial panel 112 allowing fan member 122 to freely rotate about a fixed axis of rotation. Second signal generating means 123 may preferably be defined by an annular magnet member, which magnet member comprises an outer magnet perimeter. As will be understood from an inspection of FIGS. 2 and 3, the outer magnet perimeter is substantially equal in magnitude to the inner fan frame perimeter such that the annular magnet member may be snugly received in fan member 122 substantially as illustrated in FIG. 3. The annular magnet member comprises a north pole and a south pole, either of which may be detected by a magnet sensor as fan member 122 rotates.

When in a fully assembled state, the user of BAC analyzer 100 holds proximal end 102 to his or her mouth and expels respiratory gas into respiratory gas inlet 221. The flow of respiratory gas passes through and drives (turns or rotates) fan member 122 as the respiratory gases pass over fan blades 12. Thus, fan member 122 turns or rotates about the axis of rotation extending through fan axle 121.

Preferably, the second signal generating means may be defined by an annular magnet member, the north (or south) pole of the annular magnet member is detected by signal sensor 113(b) during the rotation process to inform IC 113(a) to send out a signal through the signal line 114(b). The control circuit compares the number of revolutions of the fan and magnet assemblage (as counted by the number of times the north (or south) pole passes signal sensor 113(b)) to a predetermined (preprogrammed) value. If the predetermined value is met, then IC 113(a) sends a positive signal via signal line 114(b) to circuit board assembly 35 to cause the alcohol detecting means 34 to start sampling and testing the expelled respiratory gas passing through the device. For example, if the predetermined value is set for six (6) revolutions and the fan member 122 (with concentric annular magnet member) undergoes three (3) revolutions, no signal (or a negative “off” signal) will be sent along signal line 114(b) and thus the alcohol detecting means 34 will remain inoperative. Should the number of revolutions be insufficient as hereinabove described, the BAC analyzer 100 will display the term, “ERR” upon display screen 31 to indicate that the respiratory gas as delivered through BAC analyzer 100 was inadequate and a further sample of respiratory gas is required for an accurate rendering of the alcohol content in the respiratory gas, if any. If on the other hand, six (6) or more revolutions is detected by signal sensor 113(b), IC 113(a) sends a positive “on” signal along signal line 114(b) to cause the alcohol detecting means 34 to start sampling and testing the flowing respiratory gas and the alcohol content therein, if any.

In order to achieve the proper number of revolutions as described hereinabove, it is typically necessary for the user to expel low-lung or deep lung (alcohol-laden) respiratory gas through the alcohol detecting means 34 and, thus, the alcohol detecting means 34 may render the user a more accurate reading of the BAC. Since the implementation of this invention makes use of respiratory gas identifying assembly 1 to replace the pressure valves commonly found in prior art BAC type devices, the expulsion of respiratory gas is made smoother. Further, the present invention eliminates the requirement for replacement or installation of a blowing pipe or tube, thus increasing or enhancing the efficiency with which the device may be utilized.

It will thus be seen that the present invention may be further viewed to disclose a unique method or process for accurately analyzing the alcohol content of expelled respiratory gas. In this regard, it will be understood that the novel method for analyzing the alcohol content of expelled respiratory gas essentially comprises an initial step of expelling respiratory gas into a device such as BAC analyzer 100 as hereinabove described. The expelled respiratory gas inherently has a certain laminar flow and as earlier described, the device or BAC 100 comprises alcohol detecting means, a respiratory gas identifying assembly or respiratory gas identifying means, and a display screen or display means. It will be recalled that the respiratory gas identifying means comprises a fan member and the expelled respiratory gas passes through the alcohol detecting means and the respiratory gas identifying means. The second step in the disclosed method comprises rotating the fan member with the laminar flow of expelled respiratory gas, thereby rotating the fan member rotating a certain number of revolutions (a revolution number). The revolution number is then compared to a predetermined revolution value whereafter either a positive signal (alcohol detecting signal) or a negative signal (error message signal) is obtained or gathered. When a positive signal is obtained, the alcohol detecting means is activated. When a negative signal is obtained, an error display signal is activated. Thus, the respiratory gas is analyzed (sampled and tested) via the alcohol detecting means upon receipt of the positive signal and a respiratory gas alcohol content result is obtained from the respiratory gas analysis. Should a negative signal be obtained following the revolution number comparison (such as when a user does not expel a sufficient quantity of low-lung respiratory gas), the device will be ready for a follow-up reading whereby the steps leading up to the revolution number comparison are repeated until a positive signal is obtained. After obtaining the respiratory gas alcohol content result, the method preferably further comprises the additional step of displaying the respiratory gas alcohol content result upon the display means.

As may readily be deduced from the foregoing descriptions, the method preferably includes the use of a hand-held device or BAC analyzer 100, which device comprises a proximal end, a distal end, a superior surface, an inferior surface, and control means for selectively initiating respiratory gas analysis. It is thus contemplated that the control means may be selectively activated before the step of expelling respiratory gas into the device so as to more properly initiate respiratory gas analysis at the election of the user. Further, it will be recalled that the proximal end preferably comprises a respiratory gas inlet adjacent the superior surface and a respiratory gas outlet adjacent the inferior surface. The respiratory gas inlet is designed to receive and pass the expelled respiratory gas through the alcohol detecting means and the respiratory gas identifying means. Further, the superior surface preferably comprises display means for displaying to the user the result of the respiratory gas expulsion.

Thus, it will be seen that the present invention provides a device for analyzing the alcohol content of respiratory gas. It will be further seen that the present invention provides a portable device for analyzing the alcohol content of so-called low-lung respiratory gas. In this regard, it will be seen that the present invention provides a small compact BAC analysis device that forces the user to exhaust low-lung, residual air into the device so that sampling, testing, processing and readings may be made more accurate. While the preferred embodiment of the present invention has been described in detail, it is not intended that the novel device be limited by the foregoing descriptions. For example, it is contemplated that the present invention discloses a device for analyzing the alcohol content of expelled respiratory gas, the device preferably comprising an outer analyzer housing, a gas analysis and readout assembly, a control circuit, and power means.

The outer analyzer housing comprises a proximal end, a distal end, a superior surface, and an inferior surface. The proximal end comprises a respiratory gas inlet adjacent the superior surface and a respiratory gas outlet adjacent the inferior surface. The superior surface comprises a display screen window and a control key-receiving aperture intermediate the proximal end and the distal end. The inferior surface comprises a compartment access aperture and a compartment lid adjacent the distal end. The outer analyzer housing is essentially designed to enclose a circuit assembly-receiving compartment and a power means-receiving compartment, the circuit assembly-receiving compartment being spatially located adjacent the proximal end. The power means-receiving compartment is spatially located adjacent the distal end and the compartment lid for covering the power means-receiving compartment and the compartment access aperture.

The gas analysis and readout assembly is received in the circuit assembly-receiving compartment and comprises a circuit board assembly and a respiratory gas identifying assembly. The circuit board assembly comprises alcohol detecting means, a display screen, a control key, and a circuit board. The display screen is spatially located for positioned placement adjacent the display screen window for displaying a visual output display. The control key is received in the control key-receiving aperture and electrically coupled to the circuit board for selectively initiating respiratory gas analysis.

As earlier indicated, the central feature to the novel function of the present invention is the respiratory gas identifying assembly, which assembly comprises a frame, at least one fixing aperture, an axial panel, circuit means, first signal generating means, second signal generating means, and a circular fan member. The axial panel couples the circuit means to the first signal generating means. The fan member comprises a plurality of circumferentially spaced fan blades and a fan axle, the fan axle having an axis of rotation extending therethrough. The fan axle is operatively coupled to the axial panel and the second signal generating means is cooperatively associated with the fan member for generating a revolution signal receivable and interpretable by the first signal generating means.

The control circuit is programmed with a predetermined revolution value and compares the revolution signal to the predetermined revolution value, sending a select instructional signal to the circuit board assembly. The select instructional signal is essentially selected from the group consisting of an alcohol detector signal (a positive or “on” signal) and an error message signal (a negative or “off” signal). The alcohol detector signal, when received initiates sampling and testing of respiratory gas passing through the respiratory gas inlet, alcohol detecting means, and respiratory gas outlet. The error message signal, when received, initiates an error message display on the display screen. The sampling and testing of respiratory gas results in a respiratory gas alcohol content display.

Certain power means are received in the power means-receiving compartment for delivering operational power to the gas analysis and readout assembly. The respiratory gas inlet, when used, receives and directs or passes expelled respiratory gas through the alcohol detecting means, the respiratory gas identifying assembly, and the respiratory gas outlet. The laminar flow of the expelled respiratory gas drives or rotates the fan member and second signal generating means, the select instructional signal generate thereby providing a user with the visual output display. The visual output display is either the respiratory gas alcohol content display or the error message display as earlier described. The first signal generating means may preferably be defined by signal transmitting means and signal receiving means. A signal sensor may preferably define the signal transmitting means and an encoder integrated circuit may preferably define the signal receiving means. The fan member further preferably comprises an inner fan frame perimeter and an outer fan frame perimeter, the fan blades being integrally formed with the outer fan frame perimeter. Notably, the second signal generating means preferably being defined by an annular magnet member (comprising an outer magnet perimeter) is snugly received within the inner fan frame perimeter and thus turns with the fan member as the fan member is driven or rotated by the laminar flow. The circuit means may preferably be defined by comprising first and second power supply lines and a signal line. The first and second power supply lines electrically couple the circuit means to the circuit board assembly and the signal line electrically couples the circuit means to the control circuit.

While the above description contains much specificity, this specificity should not be construed as limitations on the scope of the invention, but rather as an exemplification of the invention. For example, it is contemplated that the spirit of the present invention lies in the use of one's expelled breath to turn a fan-based signal generator a sufficient number of turns to activate alcohol detecting means. It is noted that many of the breath analyzing devices and/or systems currently in use are costly, cumbersome machines incorporating the use of pressure valves and so forth to achieve accurate blood alcohol content readings. The present invention essentially comprises a hand-held device, which device may be brought to one's mouth for breath analysis. From one's mouth, respiratory gas may be expelled. The device thus essentially comprises a respiratory gas inlet, a respiratory gas outlet, respiratory gas identifying means disposed intermediate the respiratory gas inlet and the respiratory gas outlet, and display means disposed adjacent the respiratory gas inlet. The respiratory gas identifying means may comprise alcohol detecting means, fan-based signal generating means, and signal control means. The respiratory gas inlet may thus receive and pass expelled respiratory gas (from one's mouth) through the respiratory gas identifying means. The expelled respiratory gas thus rotates the fan-based signal generating means (the fan-based signal generating means being gas-rotatable) for generating a revolution number or number of revolutions. The signal control means monitors (or receives) and compares the revolution number to a predetermined revolution value. Once the revolution number matches the predetermined revolution value, the signal control means activates the alcohol detecting means. The alcohol detecting means then analyzes the expelled respiratory gas upon activation and provides the display means with a respiratory gas alcohol content value. Notably, the display means may be critically located upon the device so as to enable the user to readily view the display means as the user expels respiratory gas into the respiratory gas inlet. In other words, the respiratory gas inlet is designed to receive one's lips or mouth (for exhalation purposes) and the display means are designed for ready viewing adjacent one's direct line of sight all while the hand-held device is being utilized. Further, the respiratory gas outlet exhausts respiratory gas passing through the respiratory gas identifying means so as to create a more direct flow path for the expelled respiratory gas and to enhance the overall effectiveness of the present invention.

Accordingly, although the invention has been described by reference to a preferred embodiment, it is not intended that the novel assembly be limited thereby, but that modifications thereof are intended to be included as falling within the broad scope and spirit of the foregoing disclosure, the following claims and the appended drawings.

1. A device for analyzing the alcohol content of expelled respiratory gas, the device comprising:
an outer analyzer housing, the outer analyzer housing comprising a proximal end, a distal end, a superior surface, and an inferior surface, the proximal end comprising a respiratory gas inlet adjacent the superior surface and a respiratory gas outlet adjacent the inferior surface, the superior surface comprising a display screen window and a control key-receiving aperture intermediate the proximal end and the distal end, the inferior surface comprising a compartment access aperture and a compartment lid adjacent the distal end, the outer analyzer housing for enclosing a circuit assembly-receiving compartment and a power means-receiving compartment, the circuit assembly-receiving compartment being spatially located adjacent the proximal end, the power means-receiving compartment being spatially located adjacent the distal end, the compartment lid for covering the power means-receiving compartment and the compartment access aperture;
a gas analysis and readout assembly, the gas analysis and readout assembly being received in the circuit assembly-receiving compartment, the gas analysis and readout assembly comprising a circuit board assembly and a respiratory gas identifying assembly, the circuit board assembly comprising alcohol detecting means, a display screen, a control key, and a circuit board, the display screen being spatially located adjacent the display screen window for displaying a visual output display, the control key being received in the control key-receiving aperture and electrically coupled to the circuit board for selectively initiating respiratory gas analysis, the respiratory gas identifying assembly comprising a frame, at least one fixing aperture, an axial panel, circuit means, first signal generating means, second signal generating means, and a circular fan member, the axial panel coupling the circuit means to the first signal generating means, the fan member comprising a plurality of circumferentially spaced fan blades and a fan axle, the fan axle having an axis of rotation extending therethrough, the fan axle being operatively coupled to the axial panel, the second signal generating means being cooperatively associated with the fan member for generating a revolution signal receivable and interpretable by the first signal generating means;
a control circuit, the control circuit being programmed with a predetermined revolution value, the control circuit for comparing the revolution signal to the predetermined revolution value and sending a select instructional signal to the circuit board assembly, the select instructional signal being selected from the group consisting of an alcohol detector signal and an error message signal, the alcohol detector signal for initiating sampling and testing of respiratory gas passing through the respiratory gas inlet, alcohol detecting means, and respiratory gas outlet, the error message signal for initiating an error message display on the display screen, the sampling and testing of respiratory gas resulting in a respiratory gas alcohol content display; and
power means, the power means being received in the power means-receiving compartment for delivering operational power to the gas analysis and readout assembly, the respiratory gas inlet for receiving and directing expelled respiratory gas through the alcohol detecting means, the respiratory gas identifying assembly, and the respiratory gas outlet, the respiratory gas driving the fan member and second signal generating means, the select instructional signal providing a user with the visual output display, the visual output display being either the respiratory gas alcohol content display or the error message display.

2. The device of claim 1 wherein the first signal generating means is defined by signal transmitting means and signal receiving means.

3. The device of claim 2 wherein the signal transmitting means is defined by a signal sensor and the signal receiving means is defined by an encoder integrated circuit.

4. The device of claim 1 wherein the fan member comprises an inner fan frame perimeter and an outer fan frame perimeter, the fan blades being integrally formed with the outer fan frame perimeter, the second signal generating means being defined by an annular magnet member, the magnet member comprising an outer magnet perimeter, the outer magnet perimeter being received within the inner fan frame perimeter.

5. The device of claim 1 wherein the circuit means is defined by comprising first and second power supply lines and a signal line, the first and second power supply lines electrically coupling the circuit means to the circuit board assembly, the signal line electrically coupling the circuit means to the control circuit.

6. The device of claim 1 wherein in the outer analyzer casing comprises a first casing section and a second casing section, the first casing section being removably matable with the second casing section for enabling a user to selectively gain access to the circuit assembly-receiving compartment and the power means-receiving compartment.

7. The device of claim 1 wherein the superior surface comprises a transparent cover member, the transparent cover member for protecting the display window and the display screen and for enabling a user to view the visual output display.

8. A gas analysis and readout assembly for use in combination with a device for analyzing the alcohol content of expelled respiratory gas, the gas analysis and readout assembly comprising:
a circuit board assembly, the circuit board assembly comprising alcohol detecting means, a display screen, a control key, and a circuit board, the display screen for displaying messages to a user, the control key being electrically coupled to the circuit board for selectively initiating respiratory gas analysis;
a respiratory gas identifying assembly, the respiratory gas identifying assembly comprising a frame, at least one fixing aperture, an axial panel, circuit means, first signal generating means, second signal generating means, and a fan member, the axial panel coupling the circuit means to the first signal generating means, the fan member comprising at least one fan blade and a fan axle, the fan axle having an axis of rotation extending therethrough, the fan axle being operatively coupled to the axial panel, the second signal generating means being cooperatively associated with the fan member for generating a revolution signal receivable and interpretable by the first signal generating means; and
a control circuit, the control circuit being programmed with a predetermined revolution value, the control circuit for comparing the revolution signal to the predetermined revolution value and sending a select instructional signal to the circuit board assembly, the select instructional signal being selected from the group consisting of an alcohol detector signal and an error message signal, the alcohol detector signal for initiating sampling of testing of respiratory gas passing through the alcohol detecting means, the error message signal for initiating an error message display on the display screen, the sampling and testing of respiratory gas resulting in a respiratory gas alcohol content display; and
power means for delivering operational power to the gas analysis and readout assembly, the alcohol detecting means for receiving, sampling and testing expelled respiratory gas, the expelled respiratory gas driving the fan member and second signal generating means, the select instructional signal providing the user with a visual output display upon the display screen, the output display being either the respiratory gas alcohol content display or the error message display.

9. The assembly of claim 8 wherein the first signal generating means is defined by signal transmitting means and signal receiving means.

10. The assembly of claim 9 wherein the signal transmitting means is defined by a signal sensor and the signal receiving means is defined by an encoder integrated circuit.

11. The assembly of claim 8 wherein the fan member comprises an inner fan frame perimeter and an outer fan frame perimeter, the fan blades being integrally formed with the outer fan frame perimeter, the second signal generating means being defined by an annular magnet member, the magnet member comprising an outer magnet perimeter, the outer magnet perimeter being received within the inner fan frame perimeter.

12. The assembly of claim 8 wherein the circuit means is defined by comprising first and second power supply lines and a signal line, the first and second power supply lines electrically coupling the circuit means to the circuit board assembly, the signal line electrically coupling the circuit means to the control circuit.

13. A respiratory gas identifying assembly for use in combination with a device for analyzing the alcohol content of expelled respiratory gas, the respiratory gas identifying assembly comprising:
an axial panel, circuit means, first signal generating means, second signal generating means, a fan member, and a control circuit, the axial panel coupling the circuit means to the first signal generating means, the fan member comprising a fan axle, the fan axle being operatively coupled to the axial panel, the second signal generating means being cooperatively associated with the fan member for generating a revolution signal receivable and interpretable by the first signal generating means, the control circuit being programmed with a predetermined revolution value, the control circuit for comparing the revolution signal to the predetermined revolution value and sending a select instructional signal to a circuit board assembly, the select instructional signal being selected from the group consisting of an alcohol detector signal and an error message signal, the alcohol detector signal for initiating sampling of testing of respiratory gas passing through alcohol detecting means, the sampling and testing of respiratory gas resulting in a respiratory gas alcohol content signal, the alcohol detecting means for receiving, sampling and testing expelled respiratory gas, the expelled respiratory gas operably driving the fan member and second signal generating means for creating the select instructional signal.

14. The assembly of claim 13 wherein the first signal generating means is defined by signal transmitting means and signal receiving means.

15. The assembly of claim 14 wherein the signal transmitting means is defined by a signal sensor and the signal receiving means is defined by an encoder integrated circuit.

16. The assembly of claim 13 wherein the fan member comprises an inner fan frame perimeter and an outer fan frame perimeter, the fan blades being integrally formed with the outer fan frame perimeter, the second signal generating means being defined by an annular magnet member, the magnet member comprising an outer magnet perimeter, the outer magnet perimeter being received within the inner fan frame perimeter.

17. The assembly of claim 13 wherein the circuit means is defined by comprising first and second power supply lines and a signal line, the first and second power supply lines electrically coupling the circuit means to the circuit board assembly, the signal line electrically coupling the circuit means to the control circuit.

18. A respiratory gas identifying device of alcohol detector being disposed between air passage of an air inlet and an air outlet, comprising:
a frame with an axial panel for coupling a small circuit means of a signal generator, and said circuit means being capable of generating an input/output signal;
an axle of a fan blade pivotally coupled to said axial panel and having at least one signal generator, thereby air being blown into the air passage to rotate the fan blade and sensed to generate a signal during the rotation process of said signal generator; and
a control circuit for determining whether or not to start the function of said alcohol sensor if the predetermined number of signals has been met.

19. The respiratory gas identifying device of claim 18 wherein said signal generator comprises a signal receiving device and a signal transmitting device.

20. The respiratory gas identifying device of claim 19 wherein said signal receiving device is a signal sensor, and said signal transmitting device is an encoder integrated circuit.

21. The respiratory gas identifying device of claim 20 wherein said signal sensor is a magnetic sensor, and said signal generator is a magnet disposed in a frame of said fan blade.

22. The respiratory gas identifying device of claim 18 wherein said small circuit means extends two power supply lines and a signal line, respectively coupling to the circuit board of said alcohol detector.

23. The respiratory gas identifying device of claim 18 wherein said frame comprises a plurality of fixing holes disposed around the periphery of said frame, each being inserted into a fixing tenon installed on the casing.

24. A hand-held device for analyzing the alcohol content of respiratory gas, the hand-held device comprising:
a respiratory gas inlet, a respiratory gas outlet, respiratory gas identifying means disposed intermediate the respiratory gas inlet and respiratory gas outlet, and display means disposed adjacent the respiratory gas inlet, the respiratory gas identifying means comprising alcohol detecting means, fan-based signal generating means, and signal control means, the respiratory gas inlet for receiving and passing expelled respiratory gas through the respiratory gas identifying means, the fan-based signal generating means being gas-rotatable for generating a revolution number, the signal control means for receiving and comparing the revolution number to a predetermined revolution value, the signal control means for activating the alcohol detecting means when the revolution number matches the predetermined revolution value, the alcohol detecting means for analyzing the expelled respiratory gas upon activation and for providing the display means with a respiratory gas alcohol content value.

25. The device of claim 24 wherein the display means is readily viewable by a user as the user expels respiratory gas into the respiratory gas inlet.

26. The device of claim 24 wherein the respiratory gas outlet exhausts respiratory gas passing through the respiratory gas identifying means.

27. A method of accurately analyzing the alcohol content of expelled respiratory gas, the method comprising the steps of:
expelling respiratory gas into a device, the expelled respiratory gas having a laminar flow, the device comprising alcohol detecting means, respiratory gas identifying means, and display means, the respiratory gas identifying means comprising a fan member, the expelled respiratory gas passing through the alcohol detecting means and the respiratory gas identifying means;
rotating the fan member with the laminar flow, the fan member rotating a number of revolutions;
comparing the number of revolutions to a predetermined revolution value;
obtaining either a positive signal or a negative signal from the number of revolutions comparison, the positive signal for activating the alcohol detecting means, the negative signal for activating an error display;
analyzing the respiratory gas via the alcohol detecting means upon receipt of the positive signal; and
obtaining a respiratory gas alcohol content result from the respiratory gas analysis.

28. The method of claim 27 wherein the steps of: expelling respiratory gas into the hand-held device; rotating the fan member with the laminar flow; and comparing the number of revolutions to a predetermined revolution value are repeated if the negative signal is obtained during the step of obtaining either the positive signal or the negative signal from the number of revolutions comparison.

29. The method of claim 27 where the method comprises the additional step of displaying the respiratory gas alcohol content result upon the display means after the step of obtaining the respiratory gas alcohol content result from the respiratory gas analysis.

30. The method of claim 27 wherein the step of analyzing the respiratory gas via the alcohol detecting means comprises the steps of: sampling the respiratory gas and testing the respiratory gas.

31. The method of claim 27 wherein the device is a hand-held device, the hand-held device comprising a proximal end, a distal end, a superior surface, and an inferior surface, the proximal end comprising a respiratory gas inlet adjacent the superior surface and a respiratory gas outlet adjacent the inferior surface, the superior surface comprising the display means, the respiratory gas inlet for receiving and passing the expelled respiratory gas through the alcohol detecting means and the respiratory gas identifying means.

32. The method of claim 27 wherein the device comprises control means for selectively initiating respiratory gas analysis, the control means being selectively activated before the step of expelling respiratory gas into the device.
